(19) United States
(12) Patent Application Publication
(10) Pub. No.: US 2006/0287864 A1
(43) Pub. Date: Dec. 21, 2006

(54) Electronic device, computer program product and voice control method

(76) Inventors: Juha Pusa, Kangasala (FI); Sanna Lindroos, Tampere (FI); Sanna M. Koskinen, Tampere (FI); Paivi Jokinen, Tampere (FI)

Correspondence Address: Hollingsworth & Funk, LLC, Suite 125, 8009 34th Avenue South, Minneapolis, MN, 55425, US

(21) Appl. No.: 11/154,246

(22) Filed: Jun. 16, 2005

(51) Int. Cl. G10L 21/00

(52) U.S. Cl. 704/275

(57) ABSTRACT

There is provided an electronic device comprising a processing unit for controlling functions of the electronic device, an input device coupled to the processing unit for receiving voice control, and a voice recognition unit coupled to the processing unit, the processing unit being configured to control functions of the electronic device on the basis of detected voice control. The processing unit is further configured to detect an occurrence of an event processed in the electronic device, the event being set as a trigger for initiating a voice recognition process for the voice control; and to initiate the voice recognition process for the voice control when the event set as a trigger for initiating the voice recognition process is detected to occur.

### FIELD

The invention relates to a voice control method, to an electronic device, to a computer program product encoding a computer program of instructions for executing a computer process for voice control of an electronic device, and to a computer program distribution medium readable by a computer and encoding a computer program of instructions for executing a computer process for voice control of an electronic device.

### BACKGROUND

Voice recognition has been used in electronic devices, such as in mobile devices, for example for making calls to a small, predefined set of contacts in the phone book. The recognition technique used in these solutions is based on comparing the recorded voice commands to the previously stored voice recordings. There are also techniques enabling speech-to-text translations with some accuracy and thus, speaker independent commands, for example, name dialling.

The known voice recognition functions operate such that the device starts listening to the voice commands after some specific key has been pressed or a predetermined command has been given to the device. The devices cannot be listening to possible voice commands all the time because this would require constant recording and comparing and lead to draining the batteries of the devices very quickly. In addition, the risk of initiating unwanted actions would rise dramatically if the voice command function were on all the time.

### BRIEF DESCRIPTION OF THE INVENTION

An object of the invention is to provide an improved voice control method, an improved electronic device, an improved computer program product, and an improved computer program distribution medium. According to an aspect of the invention, there is provided a voice control method of an electronic device, the method comprising controlling functions of the electronic device on the basis of detected voice control. The method further comprises: detecting an occurrence of an event processed in the electronic device, the event being set as a trigger for initiating a voice recognition process for the voice control; and initiating the voice recognition process for the voice control when the event set as a trigger for initiating the voice recognition process is detected to occur.

According to another aspect of the invention, there is provided an electronic device comprising a processing unit for controlling functions of the electronic device, an input device coupled to the processing unit for receiving voice control, and a voice recognition unit coupled to the processing unit, the processing unit being configured to control functions of the electronic device on the basis of detected voice control. The processing unit is further configured to detect an occurrence of an event processed in the electronic device, the event being set as a trigger for initiating a voice recognition process for the voice control; and to initiate the voice recognition process for the voice control when the event set as a trigger for initiating the voice recognition process is detected to occur.

According to another aspect of the invention, there is provided a computer program product encoding a computer program of instructions for executing a computer process for voice control of an electronic device, the process comprising controlling functions of the electronic device on the basis of detected voice control. The process further comprises: detecting an occurrence of an event processed in the electronic device, the event being set as a trigger for initiating a voice recognition process for the voice control; and initiating the voice recognition process for the voice control when the event set as a trigger for initiating the voice recognition process is detected to occur.

According to another aspect of the invention, there is provided a computer program distribution medium readable by a computer and encoding a computer program of instructions for executing a computer process for voice control of an electronic device, the process comprising controlling functions of the electronic device on the basis of detected voice control. The process further comprises: detecting an occurrence of an event processed in the electronic device, the event being set as a trigger for initiating a voice recognition process for the voice control; and initiating the voice recognition process for the voice control when the event set as a trigger for initiating the voice recognition process is detected to occur.

According to another aspect of the invention, there is provided an electronic device comprising processing means for controlling functions of the device, input means for receiving voice control, and voice recognition means, the processing means being configured to control functions of the electronic device on the basis of detected voice control. The electronic device further comprises: detection means for detecting an occurrence of an event processed in the electronic device, the event being set as a trigger for initiating a voice recognition process for the voice control; and initiation means for initiating the voice recognition process for the voice control when the event set as a trigger for initiating the voice recognition process is detected to occur.

The invention provides several advantages. The voice recognition can be applied when it is most needed. Remote controlling of the device becomes possible. Usability of the device is greatly improved.

### LIST OF DRAWINGS

In the following, the invention will be described in greater detail with reference to the embodiments and the accompanying drawings, in which

FIG. 1 shows an example of an electronic device;

FIG. 2 shows an example of a voice control method of an electronic device, and

FIG. 3 shows another example of a voice control method.

### DESCRIPTION OF EMBODIMENTS

The invention may be applied to electronic devices, such as a mo-bile station, used as a terminal device in telecommunication systems comprising one or more base transceiver stations and terminal devices communicating with the base transceiver stations. In some embodiments of the invention, such a device comprises a possibility of short-range communication, such as a Blue-tooth chip or a transceiver functionality implemented by an infrared or a WLAN connection. The electronic device is e.g. a mobile telephone, a computer, a handheld computer or an intelligent telephone. The invention may also be applied to PDA (Personal Digital Assistant) devices which themselves comprise the necessary telecommunication properties, or to PDA devices which may be connected e.g. to a mobile telephone for a network connection. The electronic device may also be a computer or a PDA device comprising no telecommunication properties.

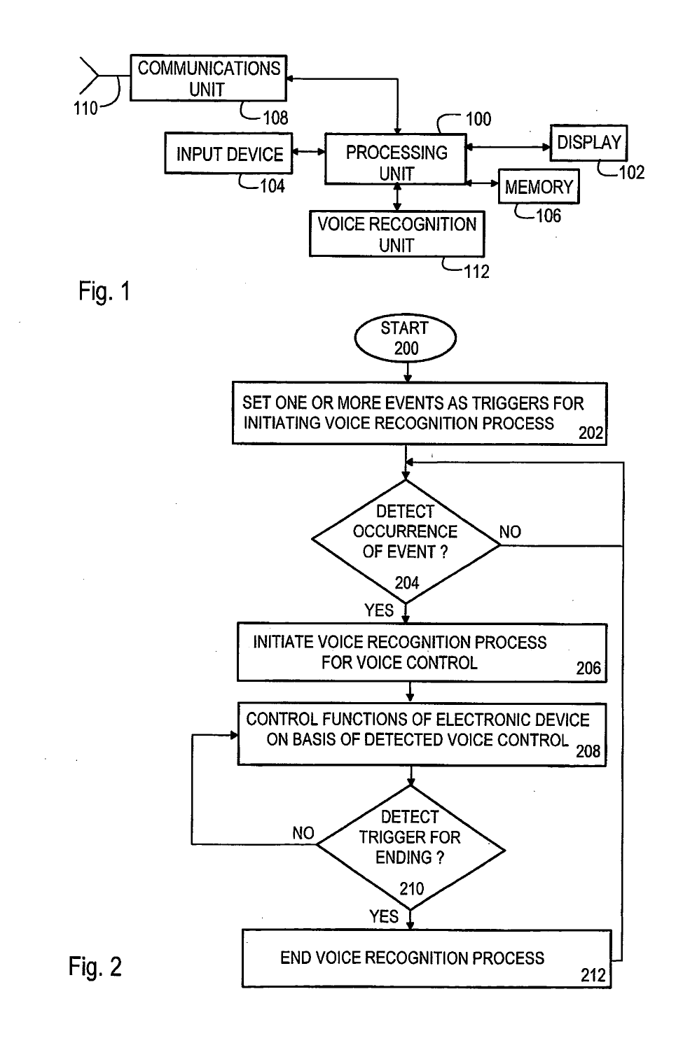

FIG. 1 is a block diagram showing the structure of an electronic device. A processing unit 100, which is typically implemented by means of a microprocessor, a signal processor or separate components and associated software, controls the basic functions of the device. The user interface of the device comprises an input device 104 and a display 102, such as a touch screen. Typically, the display 102 is a liquid crystal display. The input device 104 may comprise e.g. a mouse or a keypad.

The device may further comprise several other user interface parts, which may differ in kind and number, depending on the type of the device. The electronic device shown in FIG. 1, such as a mobile station, may also com-prise common means 108, which include speech and channels coders, modulators and RF parts, to implement the functions of the device. The device may further comprise an antenna 110 and a memory 106.

A voice recognition unit 112 coupled to the processing unit 100 takes care of the functions needed for recognizing and interpreting detected voices, such as speech. The voice recognition unit 112 may, for example, compare received voice control signals to voice control patterns stored in the memory 106 of the device. It is also possible that the voice recognition unit 112 converts received voice control signals to written text.

The input device 104 comprises a microphone via which the voice control is received in the electronic device. The voice control can be interpreted as control commands for the device. The voice control can also be interpreted as specific parameters for control commands for the electronic device. The processing unit 100 is configured to control functions of the electronic device on the basis of detected voice control. However, not all the functions of the electronic device are necessarily controlled on the basis of the voice control. The processing unit 100 may also attend to specific functions independently. Also other input means can be used to give control commands to the device.

In an embodiment, the processing unit 100 is configured to set one or more events processed in the electronic device as triggers for initiating a voice recognition process for the voice control. As the voice recognition process cannot be on all the time, predetermined events are used to trigger the voice recognition process.

In an embodiment, the one or more events processed in the electronic device set as triggers comprise one or more of the following: a start of an application, an end of an application, an incoming call, an inquiry function, an incoming connection request, a detection of a radio frequency identification tag, a start of an alarm clock alarm. Thus, the event processed in the electronic device set as a trigger for initiating a voice recognition process is an internal event of the electronic device. In order for such internal events to occur, no user input, such as pressing any keys, is required.

In an embodiment, the processing unit 100 is configured to detect an occurrence of an event processed in the electronic device, the event being set as a trigger for initiating a voice recognition process for the voice control. For example, the start of an alarm clock application may have been set as a trigger for initiating a voice recognition process for the voice control.

In an embodiment, the processing unit 100 is configured to initiate the voice recognition process for the voice control when an event set as a trigger for initiating the voice recognition process is detected to occur. Thus, for example, once the start of an alarm clock application is detected, the processing unit 100 may initiate the voice recognition process. After that, for example, giving voice control commands via the input device 104 can control the alarm clock application.

The software operating instructions encoding the computer process for voice control method may be stored in the memory 106 of the device. In an embodiment, the computer process controls functions of the electronic device on the basis of detected voice control. The computer process further sets one or more events processed in the electronic device as triggers for initiating a voice recognition process for the voice control, and initiates the voice recognition process for the voice control when an event set as a trigger for initiating the voice recognition process is detected to occur.

It is possible that specific events are set as triggers for initiating the voice recognition process in the manufacturing stage of the device. However, the triggers may also be specified by the users of the device according to their current needs. The input device 104 can be used to set the events as triggers at any time.

FIG. 2 shows an example of a voice control method of an electronic device. The method starts in 200. In 202, one or more events processed in the electronic device are set as triggers for initiating a voice recognition process for the voice control. In 204, it is detected whether an event that is set as a trigger for initiating the voice recognition process occurs. If such an event is detected, then 206 is entered where the voice recognition process for the voice control is initiated. In 208, the functions of the electronic device are then controlled on the basis of detected voice control via the voice recognition process.

In an embodiment, it is possible to set one or more events processed in the electronic device as triggers for ending the voice recognition process for the voice control. In 210, it is detected whether an event that is set as a trigger for ending the voice recognition process occurs. If such an event is not detected, the process remains in 208. If a trigger for ending the voice recognition process occurs, 212 is entered where the voice recognition process ends. Then 204 can be entered again where the occurrence of events set as triggers are detected.

The initiated voice recognition process can be set to end in many different ways. One option is to set specific triggers for ending the voice recognition process as described in connection with FIG. 2. The one or more events processed in the electronic device set as triggers for ending may comprise one or more of the following: a start of an application, an end of an application, an incoming call, an inquiry function, an incoming connection request, a detection of a radio frequency identification tag. In an embodiment, such is also possible that once the voice recognition process has been initiated, the processing unit starts taking time at the same time. Thus, once a predetermined time has lapsed and no voice control commands have been received during that time, the processing unit may then end the voice recognition process. The voice recognition process may be ended, for example, when no voice control has been detected during a predetermined period of time.

In an embodiment, the voice recognition is set to start in specific, for example in safe, situations. From the user's perspective, the voice recognition process starts automatically. When a trigger event occurs, the electronic device starts listening to possible voice commands. One possible use case is the snooze function of an alarm clock. The alarm clock alarming function can be set as a trigger for initiating the voice recognition process. Thus, once the alarm clock starts alarming, the device initiates the voice recognition process and starts listening to possible voice commands. The user of the device can then simply say the voice command for snoozing instead of first finding the device and the corrects key(s) to press. In this case, even a misinterpretation would not cause harm to the user.

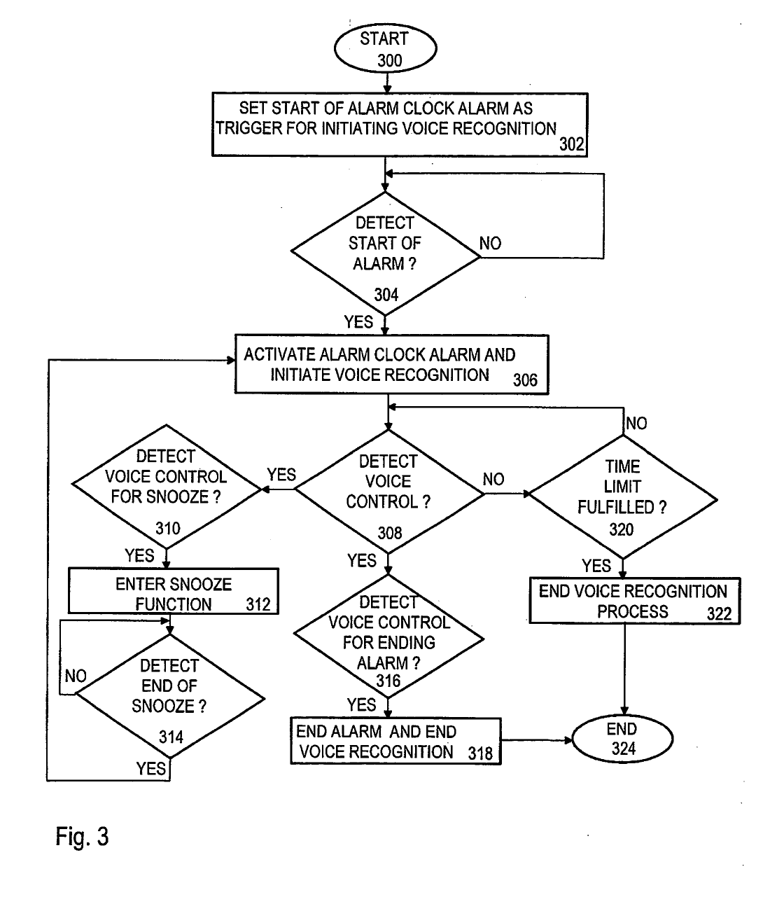

FIG. 3 shows an example of a voice control method where an alarm clock application is used as an example. The method starts in 300. In 302, the start of the alarm of an alarm clock application is set as a trigger for initiating the voice recognition process for voice control. In 304, the start of an alarm clock application is detected. If, in 304, the start of an alarm clock application is detected, then 306 is entered where the alarm clock alarm function is activated and the voice recognition process for voice control is initiated. In 308, possible voice control is detected. If voice control is not detected, in 320 it is detected whether a predefined time limit has been fulfilled. The time limit may be, for example, some seconds or minutes starting from the initiation of the voice recognition process. If the time limit is not fulfilled, the detection of possible voice control is continued. If the predetermined time limit, in 320, is detected to have been fulfilled, then 322 is entered where the voice recognition process is ended. Thus, it is possible to make sure that unnecessary battery power is not consumed in a situation where the user of the device is not in the hearing vicinity of the device when the alarm is activated, for example.

In 310, if it is detected that a voice control for snooze function is received, then 312 is entered where the snooze function is activated. In 314, if the end of the snooze function is detected, then 306 is returned where the alarm is activated again and the voice recognition process is initiated. In 316, if it is detected that a voice control for ending the alarm function is received, then 318 is entered where the alarm clock application and the voice recognition process are ended. The method ends in 324.

In an embodiment, a detection of an RFID (Radio Frequency Identification) tag can be set as a trigger for initiating the voice recognition process. For example, a profile change can be initiated with an RFID tag, and as the voice recognition process is initiated at the same time, the user simply has to say the profile name he wants in order to get the profile changed. In this case, the voice command is used as a parameter for a command instead of being a command itself. This kind of physical action or context change combined with a voice parameter input can be useful is many situations. The voice recognition can be applied when it is most suitable. The embodiments of the method can be used, for example, as an alternative input method of the device in specific situations where this kind of effortless or remote controlling of the device is beneficial.

The embodiments of the invention may be realized in an electronic device, comprising a processing unit operationally connected to an input device and a voice recognition unit, for example. The processing unit may be configured to perform at least some of the steps described in connection with the flowcharts of FIGS. 2 and 3. The embodiments may be implemented as a computer program comprising instructions for executing a computer process for voice control of an electronic device.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention is described above with reference to an example according to the accompanying drawings, it is clear that the invention is not restricted thereto but it can be modified in several ways within the scope of the appended claims.

1. A voice control method of an electronic device, the method comprising controlling functions of the electronic device on the basis of detected voice control, the method further comprising:
detecting an occurrence of an event processed in the electronic device, the event being set as a trigger for initiating a voice recognition process for the voice control; and
initiating the voice recognition process for the voice control when the event set as a trigger for initiating the voice recognition process is detected to occur.

2. The method of claim 1, the method further comprising setting one or more events processed in the electronic device as triggers for initiating the voice recognition process for the voice control.

3. The method of claim 2, wherein the step of setting the one or more events as triggers for initiating the voice recognition process is based on control commands received from an input device.

4. The method of claim 1, wherein the event processed in the electronic device is an internal event of the electronic device.

5. The method of claim 1, further comprising setting one or more events processed in the electronic device as triggers for ending the voice recognition process for the voice control; and ending the initiated voice recognition process when an event set as a trigger for ending the voice recognition process is detected to occur.

6. The method of claim 1, further comprising using a detected voice control as a control command for the electronic device.

7. The method of claim 1, further comprising using a detected voice control as a parameter for a control command for the electronic device.

8. The method of claim 1, wherein the event processed in the electronic device set as triggers comprise one or more of the following: a start of an application, an end of an application, an incoming call, an inquiry function, an incoming connection request, a detection of a radio frequency identification tag, a start of an alarm clock alarm.

9. An electronic device comprising a processing unit for controlling functions of the electronic device, an input device coupled to the processing unit for receiving voice control, and a voice recognition unit coupled to the processing unit, the processing unit being configured to control functions of the electronic device on the basis of detected voice control, the processing unit being further configured to detect an occurrence of an event processed in the electronic device, the event being set as a trigger for initiating a voice recognition process for the voice control; and to initiate the voice recognition process for the voice control when the event set as a trigger for initiating the voice recognition process is detected to occur.

10. The electronic device of claim 9, wherein the processing unit is further configured to set one or more events processed in the electronic device as triggers for initiating the voice recognition process for the voice control.

11. The electronic device of claim 10, wherein the processing unit is configured to set the one or more events as triggers for initiating the voice recognition process on the basis of control commands received from the input device.

12. The electronic device of claim 9, wherein the event processed in the electronic device is an internal event of the electronic device.

13. The electronic device of claim 9, wherein the processing unit is further configured to set one or more events processed in the electronic device as triggers for ending the voice recognition process for the voice control; and to end the initiated voice recognition process when an event set as a trigger for ending the voice recognition process is detected to occur.

14. The electronic device of claim 9, wherein the processing unit is configured to use the detected voice control as a control command for the electronic device.

15. The electronic device of claim 9, wherein the processing unit is configured to use the detected voice control as a parameter for a control command for the electronic device.

16. The electronic device of claim 9, wherein the events processed in the electronic device set as triggers comprise one or more of the following: a start of an application, an end of an application, an incoming call, an inquiry function, an incoming connection request, a detection of a radio frequency identification tag, a start of an alarm clock alarm.

17. A computer program product encoding a computer program of instructions for executing a computer process for voice control of an electronic device, the process comprising controlling functions of the electronic device on the basis of detected voice control, the process further comprising:
detecting an occurrence of an event processed in the electronic device, the event being set as a trigger for initiating a voice recognition process for the voice control; and
initiating the voice recognition process for the voice control when the event set as a trigger for initiating the voice recognition process is detected to occur.

18. The computer program product of claim 17, the process further comprising: setting one or more events processed in the electronic device as triggers for initiating the voice recognition process for the voice control.

19. A computer program distribution medium readable by a computer and encoding a computer program of instructions for executing a computer process for voice control of an electronic device, the process comprising controlling functions of the electronic device on the basis of detected voice control, the process further comprising:
detecting an occurrence of an event processed in the electronic device, the event being set as a trigger for initiating a voice recognition process for the voice control; and
initiating the voice recognition process for the voice control when the event set as a trigger for initiating the voice recognition process is detected to occur.

20. The computer program distribution medium of claim 19, the distribution medium including at least one of the following mediums: a computer readable medium, a program storage medium, a record medium, a computer readable memory, a computer readable software distribution package, a computer readable signal, a computer readable telecommunications signal, and a computer readable compressed software package.

21. An electronic device comprising processing means for controlling functions of the device, input means for receiving voice control, and a voice recognition means, the processing means being configured to control functions of the electronic device on the basis of detected voice control, the electronic device further comprising: detection means for detecting an occurrence of an event processed in the electronic device, the event being set as a trigger for initiating a voice recognition process for the voice control; and initiation means for initiating the voice recognition process for the voice control when the event set as a trigger for initiating the voice recognition process is detected to occur.

22. The electronic device of claim 21, wherein the electronic device further comprises setting means for setting one or more events processed in the electronic device as triggers for initiating the voice recognition process for the voice control.
